(19) United States
(12) Patent Application Publication
(10) Pub. No.: US 2009/0033643 A1
(43) Pub. Date: Feb. 5, 2009

(54) INTEGRATED DISPLAY MODULE

(75) Inventors: John F.L. Schmidt, Phoenix, AZ (US); Elias S. Haim, Glendale, AZ (US); Jeffrey W. Krause, Glendale, AZ (US); David Looney, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/830,595

(22) Filed: Jul. 30, 2007

(51) Int. Cl. G09G 5/00

(52) U.S. Cl. 345/205; 345/102; 345/87

(57) ABSTRACT

A display device includes a substrate. At least a portion of a plurality of pixel circuits are disposed over or integrated into a first surface of the substrate, and arranged in a matrix. A control device is disposed over a second surface of the substrate.

### FIELD OF THE INVENTION

The present invention generally relates to displays, and more particularly relates to constructing highly integrated display modules which incorporate supplemental electronics into the display panel's design using polysilicon devices, or an alternate technology which enables complex electronic functions to be constructed as part of the display.

### BACKGROUND OF THE INVENTION

Flat panel displays such as liquid crystal displays and organic light emitting diode (AM-OLED) displays employ circuit cards with integrated circuits to provide display functionality, and to interface with the display's host hardware configuration. The circuit cards provide display operating voltages, video data and timing control signals, and display calibration voltages and currents which maximize display performance for the intended application.

Flat panel displays utilize a variety of electronic control circuits to drive an image, such as scan drivers, data drivers, backlight controllers, and the like. The scan and data drivers are highly integrated silicon devices which combine analog and digital functional blocks to drive the display panel. The LCD drivers are typically mounted on a flexible polyamide or polyester film which connects to the display substrate on one side and the system interface circuit cards on the other side. The system interface electronic circuits have traditionally been located on a separate circuit board which is located apart from the display substrate. Such a configuration may necessitate third party electronic components, supplemental circuit cards, and expensive system interconnects, which may add to the display's overall cost.

Accordingly, it is desirable to provide an apparatus and method for integrating display control electronics and display dimming control circuitry into the display's design. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various exemplary embodiments demonstrate how integrated electronics may be incorporated into the display design, such as on thin-film transistor (TFT) substrate.

In one embodiment, by way of example only, the present invention is a display device, including a substrate. A plurality of pixel circuits is at least partially disposed over or integrated into a first surface of the substrate and arranged in a display matrix. A control device is disposed over or integrated into a second surface of the substrate. The integrated electronic components are integrated into or disposed over the substrate so as to not interfere with a pixel aperture of the display. In the case of a liquid crystal display with a backlight, light passes from the backlight through the display substrate via the pixel aperture. In the case of a transflective liquid crystal display, the pixel aperture can pass light from the backlight, or it can reflect light from the incident light source. In these two cases, supplemental electronic components may be placed in the display periphery, or under the light blocking layer that occludes the row and column lines in the display substrate. In the case of a self-emissive display, such as an Organic Light Emitting Diode (OLED) display, light originates from the pixel aperture. Supplemental electronic components may be placed under the light blocking layer, or they may be placed on the display's back surface, where self-emitted light does not pass.

### BRIEF DESCRIPTION OF THE DRAWINGS

The present invention will hereinafter be described in conjunction with the following drawing figures, wherein like numerals denote like elements, and

FIG. 1 is a conceptual illustration of a prior art liquid crystal display (LCD) system;

FIG. 2A is an exemplary prior art LCD display matrix;

FIG. 2B is an exemplary prior art OLED display matrix;

FIG. 3 is a conceptual illustration of an exemplary display system according to the present invention;

FIG. 4A is a cutaway representation of a first exemplary display;

FIG. 4B is a cutaway representation of a second exemplary display;

FIG. 4C is a conceptual, top view representation of a third exemplary display; and

FIG. 4D is a conceptual, top view representation of a fourth exemplary display.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various aspects of the exemplary embodiments may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements and/or the like, which may carry out a variety of functions under the control of one or more microprocessors or other control devices. In addition, the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The present invention substantially improves upon the prior art, and provides reduced display system complexity, reduces system changes that result from third party device obsolescence over the display product's life cycle, and reduces display system cost. The present invention integrates supplemental display system electronics into the display's design, thereby eliminating the need for specific third party electronic components, supplemental circuit cards, and expensive system interconnects.

Prior art flat panel display configurations exist in abundance. Prior art includes many commonly available liquid crystal displays which employ color filters arranged in three to four color dot groups to produce a single display picture element (pixel). Furthermore, said pixels are arranged in an XY grid to produce a display. The prior art employs backlights to project light through a liquid crystal display, or self-emissive media in the case of AM-OLED displays.

A rigid or flexible substrate is generally employed to support components of the display which are formed over, or fabricated over, the substrate. For example, a substrate is employed to support an active matrix switch array, also known in some embodiments as a thin-film-transistor (TFT) array. The substrate can be glass, plastic, stainless steel, or some other suitable material which is compatible with TFT array processing. For this discussion, a glass substrate will be assumed. However, this assumption does not limit the scope or applicability of the invention to glass, as the concepts presented herein apply equally well to other substrate materials, such as stainless steel and plastic.

The present invention integrates electronic control circuitry typically removed from the display onto or into the display itself, as will be further described. The circuitry can be located on a rear surface of the substrate, where it can be adhered to the substrate or disposed over the substrate using typical semiconductor processing technologies. In addition, the circuitry can be integrated into the display matrix, by placement alongside resident electronics (e.g., thin film transistors) already incorporated into the display. Such an implementation is strategically designed so as not to obstruct the pixel structures of the display. Finally, the circuitry can be integrated into the display along a peripheral edge of the display matrix, again placed so as not to obstruct the pixel. Such circuitry may be disposed over the substrate, or fabricated over the substrate, to suit a particular application.

Integration of such control circuitry as will be further described may be applied to a host of display technologies, includes liquid crystal displays (LCD) device, light emitting displays (LED) such as an organic light emitting diode (OLED) device, field emission displays (FED), and plasma display panel (PDP) devices. Additionally, the discussion has applications to several variations of the described technologies, such as so-called “super-twist” displays.

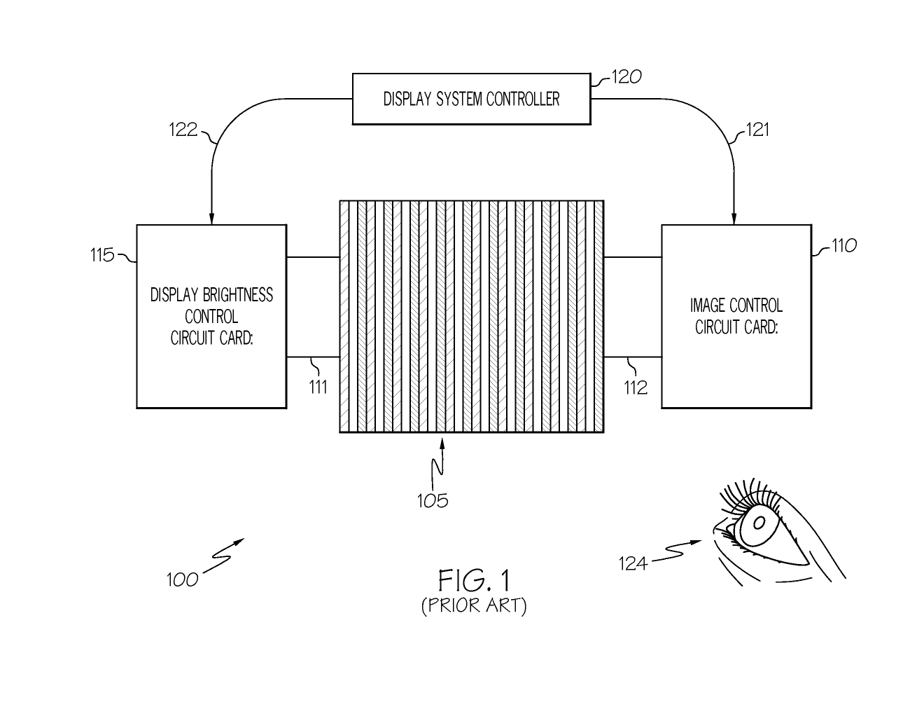

Turning to FIG. 1, a conceptual diagram of a prior art LCD display system is depicted. System 100 includes an LCD display panel 105 which is viewed by an observer 124. Electronic control circuitry, such as an image control circuit card 110 and a display brightness control circuit card 115, are coupled to the LCD panel 105 by means of interconnects 111 and 112. Such control circuitry exists separately from the display panel 105 as shown. For example, the image control circuitry is integrated into a card 110. System 100 includes an overall display system controller 120 which again, is housed on a separate card and connected to cards 110 and 115 via interconnects 121 and 122, respectively.

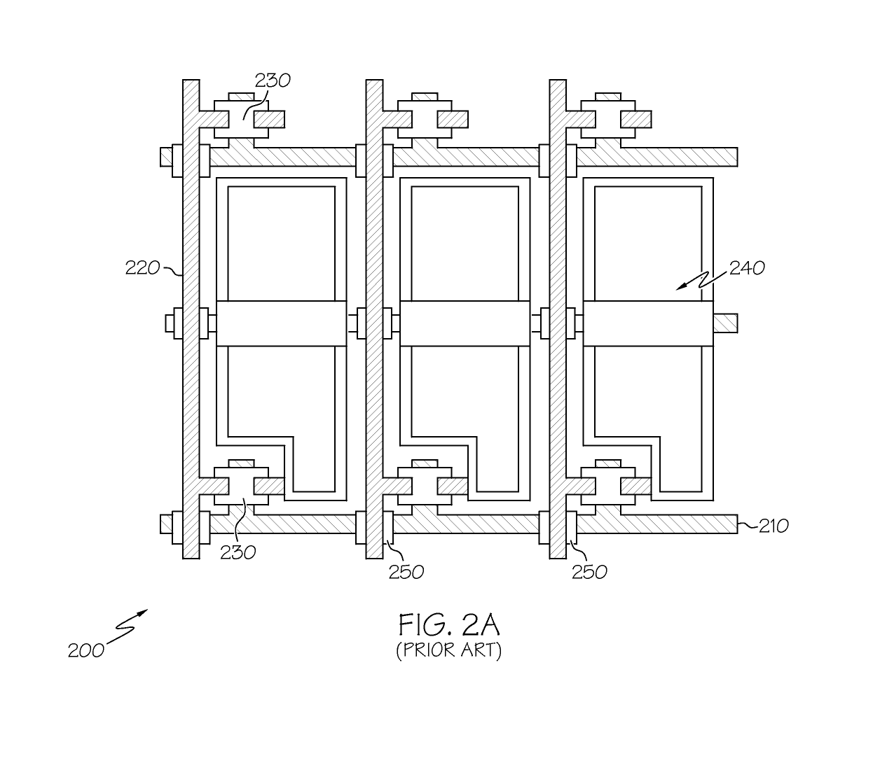

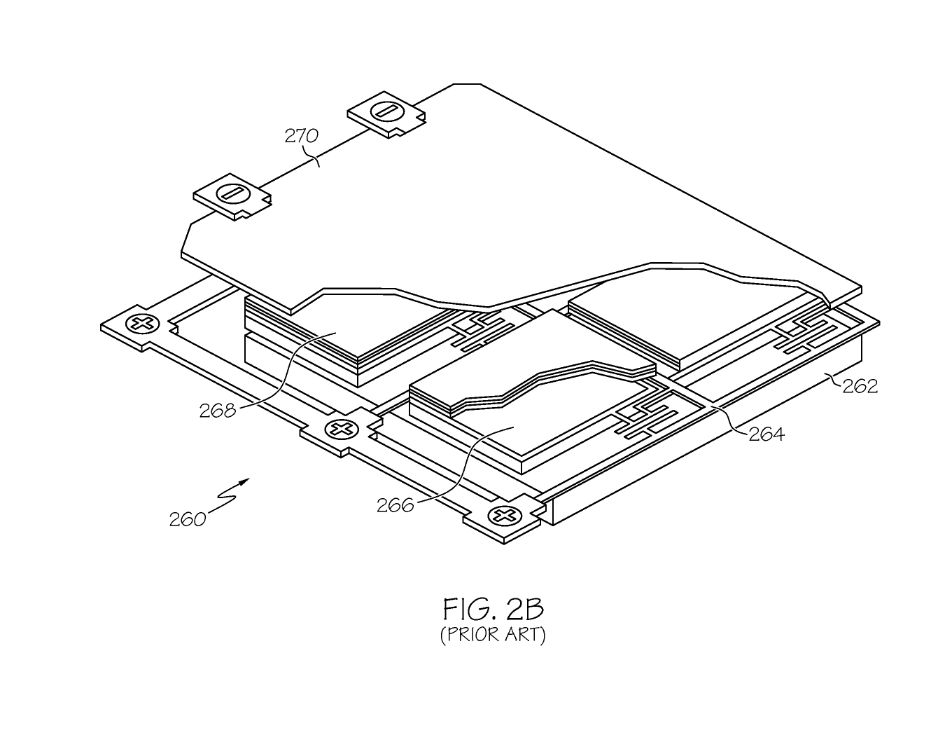

FIG. 2A conceptually illustrates a portion of a typical TFT array for a liquid crystal display panel 200. As one skilled in the art will appreciate, an exemplary method of manufacturing such a panel 200 begins with bare substrate, such as thin-film transistor (TFT) substrate. An array of rows and columns is constructed over the substrate, where the columns are orthogonal to the rows, and where the number of columns defines the horizontal display resolution and the number of rows defines the vertical display resolution.

The array of rows and columns is constructed on a light-blocking layer, also called a light shield, which possesses the shape of the row and column matrix. The light blocking layer is omitted from the pixel area 240, where light must be emitted, or where light must pass from the backlight to the display observer. The light blocking layer prevents light from impinging on the thin film transistors (TFTs) 230, which are photosensitive. Furthermore, where rows and columns intersect a TFT switch is placed. An insulating pad 250 is place at the points where gate lines cross over source lines, to prevent gate-to-source shorts. The gate, or enable signal of the TFT is connected to the proximate row bus 210, and the source, or programming terminal of the TFT is connected to the proximate column bus 220.

The TFT drain connection is tied to the pixel 240, which can be programmed to a fixed number of brightness states, depending on the programming current or voltage applied through the TFT. The display rows are connected to row driver electronic components, and the display columns are connected to column driver electronic components. For the purpose of this discussion, the terms gate driver and row driver may be synonymously applied, and likewise, column driver or source driver may also be synonymously applied. Source and gate drivers are generally constructed on a silicon substrate which is further attached to a flexible foil, which can then be attached to the display assembly on one side, and the electrical circuit card on the other side. The gate and source drivers provide highly integrated functionality in a very small mechanical footprint.

FIG. 2B conceptually illustrates a portion of another exemplary display technology, an active matrix OLED display 260. An OLED does not have liquid crystal material. An OLED has a multilayer stack of thin organic films 268 which form an organic light emitting diode between the substrate 262 and the top glass cover 270 (or plastic cover). The top and bottom glass layers have a metal deposition which contacts the OLED layer stack. The bottom glass can be the anode 266 and the top glass can be the cathode 270. In active matrix OLED displays, the anode layer 266 overlays a thin film transistor (TFT) array 264 that forms a matrix. When current flows from the bottom glass through the organic layers to the top layer, light is emitted from the organic light emitting layer. The other organic layers help to facilitate.

The TFT array for an active matrix OLED display is similar, though more complex, than the active matrix array for the LCD. LCDs only need 1 TFT per pixel. OLED displays typically have from 2 to 5 TFTs in the pixel. This stems from the fact that OLEDs must be programmed with a current that continuously flows when the display pixel is operating. An LCD uses a time varying voltage to change the liquid crystal material properties; no steady current flows in the LCD. The extra TFTs in an OLED are needed to stabilize the TFT's performance, and provide a programmed current to set the OLED display's brightness.

The following description is unique in its application to a variety of flat panel displays, in that normally unused areas of the display can house integrated electronics, thereby reducing or eliminating the need for supplemental electronic components to operate the display. Using these areas can reduce system complexity and cost, and eliminate some part obsolescence issues. Depending on the technology of any particular flat panel display, the back side of the TFT substrate, the TFT substrate's peripheral area, or the area under the light shield may be used for integrated electronics that would otherwise be placed on auxiliary circuit cards.

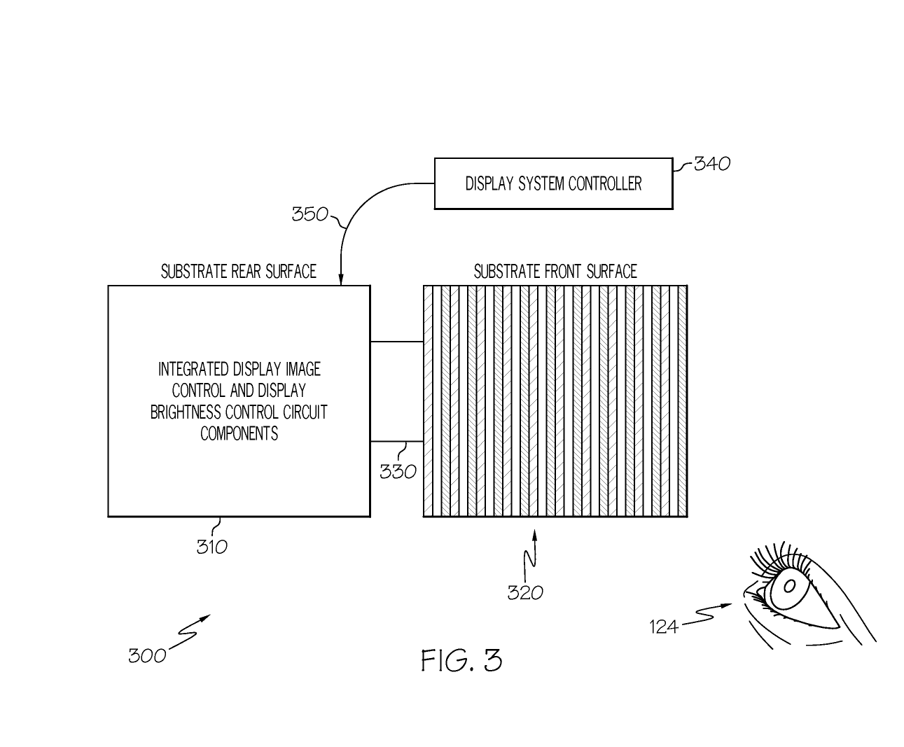

Bearing the previous discussion in mind, FIG. 3 is a conceptual illustration of an exemplary display system in accordance with the present invention. A single display device 300 is conceptually divided between substrate rear surface 310 and substrate front surface 320. The display 300 is again viewed by an observer 124. A variety of control electronics, including control electronic circuitry, is integrated over or into the rear surface of the substrate 310. Such control electronics and circuitry may be referred to as a “control device” or “control circuits” although they may include one or more discrete components or circuits. For purposes of the present description, a “control circuit” or a “control device” does not refer to such components as resident TFTs which effectively switch a pixel circuit “on” or “off.” Rather, for purposes of this discussion, resident TFTs and similar components are grouped as part of a categorization of resident electronic circuits, which can be referred to as “pixel circuits.” These pixel circuits are designated as such, in part, to distinguish them from the control and driver electronics which have previously been located apart from the display itself.

Electrical connectivity to the front surface 320 of the display is maintained through interconnects 330. In one embodiment, the interconnect 330 can include structures such as flexible interconnect foil. The display 300 is coupled to a system controller 340 via an interconnect 350, although, in other embodiments, the controller 340 may also be integrated in or over the rear surface 310.

As one skilled in the art will appreciate, the various electronic control components and circuitry can vary according to the particular type of display. For example, the control components may include a scan driver for applying a gate voltage to select pixel circuits integrated in the display matrix. The control components may include a source driver for applying a data voltage to the pixel circuits. For non-self emissive displays, the control components may include a backlight controller for applying a backlight control signal. Finally, the control components may include a timing controller for applying a control signal. Similar electronics and associated circuitry may also be included.

As will be further described, such electronic control components and circuitry may be disposed over or integrated into the rear surface 310 of the substrate using traditional techniques known in the semiconductor industry, such as masking, etching, photolithography, material deposition such as chemical vapor deposition (CVD), and the like. In other embodiments, the circuitry and components may be formed and adhered to the substrate using an adhesive material, such as a die attach (DA) adhesive. In further embodiments, the control circuitry and components may be integrated into the front surface of the display matrix along with existing circuitry and components. Finally, the control circuitry may be integrated along peripheral edges of the front surface of the substrate. In both of the latter embodiments, placement of such electronics can occur so as not to obstruct the flow of light through the display aperture, or to impede light emitted from a self-emissive display.

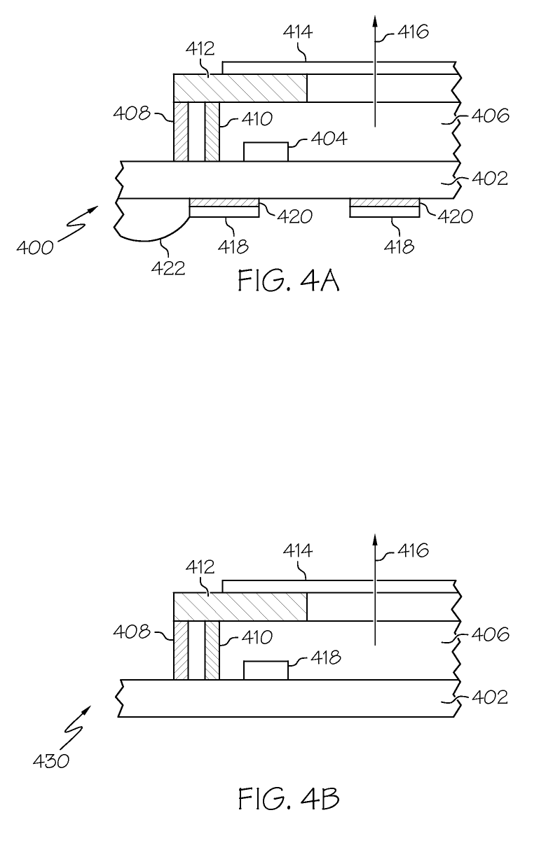

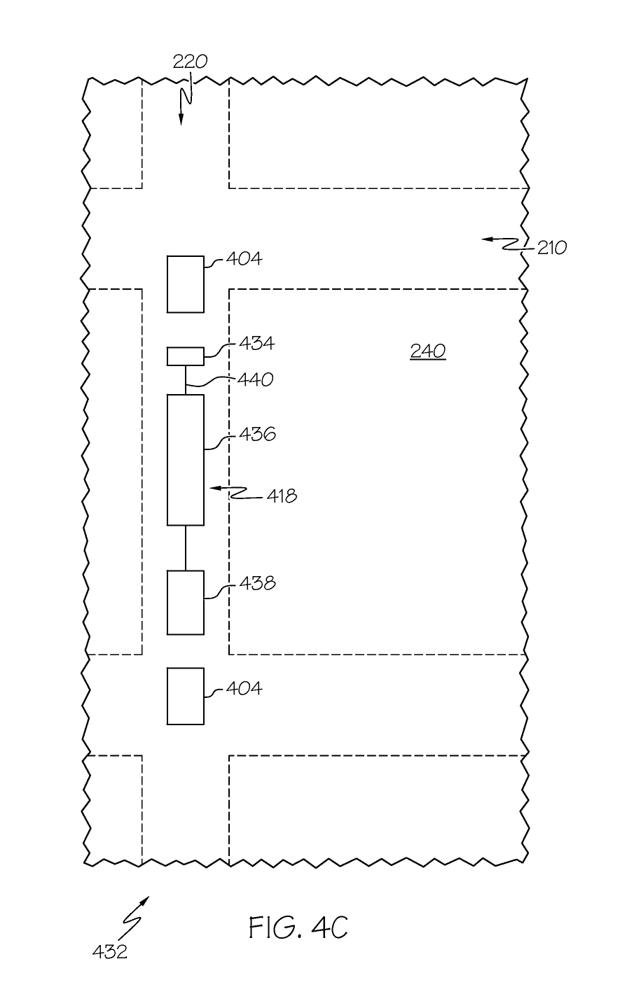

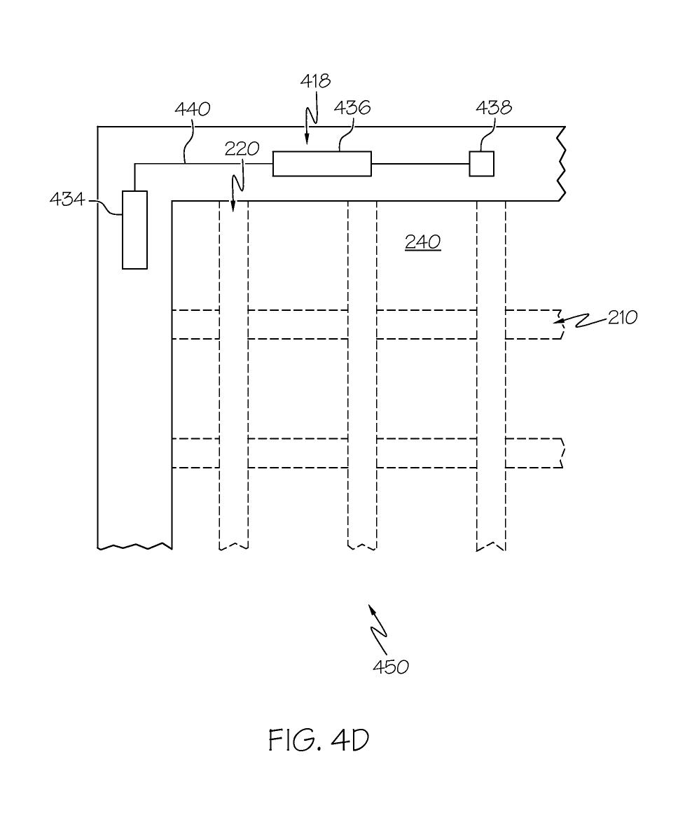

FIG. 4A illustrates a first exemplary conceptual embodiment of a portion of a LCD display 400 in accordance with the present invention. Before continuing, it will be appreciated that although the present depiction relates to the LCD technology described by FIG. 2A, the integration described thorough this discussion may be incorporated into a variety of displays such as OLED display technology described by FIG. 2B. For example, while FIG. 2A depicts LCD technology, one skilled in the art will appreciate the similarities associated with other display technologies (e.g., the various components, be it LCD, OLED or the like, are all disposed over a first surface of the substrate and arranged at least partially in a display matrix).

In the depicted exemplary embodiment shown in FIG. 4A, the various control components and circuitry are formed over or integrated into the rear surface of the display substrate 402. On the front surface of the substrate are deposited various structures commonly seen in such display devices. For purposes of illustration, various subcomponents of these structures are not illustrated, but can be appreciated by one skilled in the art. A TFT 404 is deposited above the substrate, a portion of which is enclosed by liquid crystal 406. Portions of insulating pad 408 and seal 410 are shown. Structure 412 includes a light blocking portion which forms the display matrix. Another portion of the structure 412 is clear to allow for the emission of light from the underlying liquid crystal. A polarizing layer 414 is disposed over the structure 412. A second polarizing layer would normally be integrated into the display, but is not shown for purposes of convenience. Arrow 416 represents the movement of visible light from the energized liquid crystal to an observer.

Moving to the back surface of the substrate 402, a series of electronic components 418 are seen disposed over the substrate using an adhesive 420. Again, alternatively, the components are formed over the substrate directly or integrated into the substrate using a series of the manufacturing steps mentioned previously. A portion of lead 422 is shown connecting the electronic components 418. Lead 422 may be part of a larger conductive device, such as a flexible foil interconnect, or may consist of lead wires which can be fixed to such structures as bond pads. Lead 422 can be a portion of the interconnect which provides electrical connectivity between the TFTs 404 and related electronics on the front surface of the display and the control components on the rear surface.

Electronic components 418 can include discrete components such as transistors, diodes, resistors, capacitors, and the like, and integrated circuits. As will be described further, the electronic components may be connected using a variety of means known in the art, such as wire bonding or through the use of conductive layers formed in or over the substrate itself.

Turning to FIG. 4B, a second conceptual exemplary embodiment of the present invention is illustrated, which depicts a portion of a LCD device 430. Various display components are again shown, such as structure 412, polarizing layer 414, etc. Electronic component 418 is seen disposed under the light blocking portion of the structure 412. In the depicted embodiment, various electronic components 418, along with TFTs and related TFT switches (not shown), are integrated together along the display matrix. Since the present illustration is a side view representation, only the component 418 is shown. As one skilled in the art will appreciate, the control components 418 can be configured and oriented so as to fill unused space under the light blocking portion. Again, such an implementation may be applied to other technologies, such as an active matrix OLED display. In each configuration and orientation, a designer can strategically position control components along with existing electronics so as not to obstruct the flow of light from the pixel aperture. Returning again to FIG. 4A, in cases where translucency of the substrate 402 is desired (for example, in displays using a backlight), the control components 418 can be also positioned strategically in or on the rear surface of the substrate to correspond to the display matrix on the front surface of the substrate, again so as not to obstruct the flow of light.

FIG. 4C illustrates a conceptual, top view illustration of an additional display device 432. Display device 432 can be a variety of display devices, such as the aforementioned liquid crystal display (LCD) devices, light emitting displays (LED) such as the organic light emitting diode (OLED) devices, field emission displays (FED), and plasma display panel (PDP) devices. Here again, a display matrix of row buses (gate lines) 210 are illustrated along with column busses (source lines) 220. The display matrix may vary according to the particular display technology. The row buses and column busses are covered by a light blocking structure, which is conceptually illustrated with the depicted dotted lines. A series of electronic control components 418, such as components 434, 436, and 438, are disposed under the light blocking structure. Lead 440 connects component 434 with 436. Again, as one skilled in the art will appreciate, lead 440 can be a wire bond or a conductive layer integrated into or formed over the substrate.

Components 434, 436, 438, and others are strategically placed under the light blocking portion so as not to obstruct the pixel portion 240. The components 434, 436 and 438 are positioned in combination with existing TFTs 404 and related circuitry and components. The components 434, 436, and 438 may be integrated with the existing circuitry as part of a single or multiple conductive layers, for example. Here again, components 434, 436, 438 and others may include discrete components such as resistors, diodes, capacitors, and the like, as well as integrated components such as integrated circuits or even dies.

Turning to FIG. 4D, an additional conceptual top view illustration 450 of a portion of an additional exemplary display is depicted to show an alternative embodiment of the present invention. The display matrix may again vary depending on a particular display technology. Again, the display matrix is seen with row busses 210 and column busses 220 disposed beneath the light blocking portion, which defines the individual pixels 240. TFTs 404 are not shown for illustrative convenience. A variety of control components and associated circuitry is disposed along a peripheral edge of the display matrix. Again, for conceptual purposes, control circuits and circuitry 418 includes components 434, 436, and 438. Lead 440 connects component 434 with 436. Components 434, 436, 438 and others are strategically placed along a peripheral edge of the display so as not to obstruct the display. The components may be oriented and configured in a highly dense implementation intended to limit the additional dimensions (width and length) of the display and display substrate. In one embodiment, the components may be completely oriented along a single side or a single area of the display to suit a particular application. The embodiment of FIG. 4D may be suitable for such technologies as passive matrix OLED displays, where resident electronics are integrated around peripheral edges of the various layers. In such a case, control electronics may simply be integrated alongside such resident electronics.

It should be appreciated that the example embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A display device, comprising:
a substrate;
a plurality of pixel circuits, at least a portion of the plurality of pixel circuits disposed over or integrated into a first surface of the substrate and arranged in a matrix; and
a control device, disposed over or integrated into, a second surface of the substrate.

2. The device of claim 1, further including a connecting circuit providing electrical communication between the control device and the plurality of pixel circuits.

3. The device of claim 1, wherein the control device includes a plurality of electronic components connected by a plurality of electronic circuits.

4. The device of claim 2, wherein the connecting circuit further includes a flexible foil connector.

5. The device of claim 1, wherein the control device is adhered to the second surface of the substrate using an adhesive material.

6. The device of claim 1, wherein the control device is a scan driver for applying a gate voltage to select the plurality of pixel circuits.

7. The device of claim 1, wherein the control device is a source driver for applying a data voltage to the plurality of pixel circuits.

8. The device of claim 1, wherein the control device is a backlight controller for applying a backlight control signal.

9. The device of claim 1, wherein the control device is a timing controller for applying a timing control signal.

10. The device of claim 1, wherein the display device includes a liquid crystal display (LCD) device, an organic light emitting diode (OLED) device, a field emission display (FED) device, or a plasma display panel (PDP) device.

11. A method of manufacturing a display device, comprising:
providing a substrate;
forming a plurality of a plurality of pixel circuits, at least a portion of the plurality of pixel circuits disposed over or integrated into a first surface of the substrate and arranged in a matrix; and
disposing a control device over, or integrating the control device into, a second surface of the substrate.

12. The method of manufacture of claim 11, further including a coupling a connecting circuit providing electrical communication between the driver device and the plurality of pixel circuits.

13. The method of manufacture of claim 11, wherein disposing a control device over, or integrating the control device into, a second surface of the substrate includes forming a plurality of electronic components connected by a plurality of electronic circuits.

14. The method of manufacture of claim 11, wherein disposing a control device over, or integrating the control device into, a second surface of the substrate includes adhering the driver device to the second surface of the substrate using an adhesive material.

15. The method of manufacture of claim 13, wherein disposing a control device over, or integrating the control device into, a second surface of the substrate further includes disposing a scan driver for applying a gate voltage to select the plurality of pixel circuits, disposing a source driver for applying a data voltage to the plurality of pixel circuits, disposing a backlight controller for applying a backlight control signal, or disposing a timing controller for applying a timing control signal.

16. A display device, comprising:
a substrate;
a plurality of pixel circuits, at least a portion of the plurality of pixel circuits disposed over or integrated into the substrate and arranged in a display matrix; and
a plurality of control circuits, disposed over or integrated into the substrate, and arranged along portions of the display matrix so as not to obstruct a pixel aperture.

17. The device of claim 16, further including a light-blocking layer disposed over a portion of the display matrix and the plurality of control circuits.

18. The device of claim 16, wherein the plurality of control circuits includes a plurality of electronic components connected by a plurality of electronic circuits.

19. The device of claim 16, wherein the plurality of control circuits comprises a scan driver for applying a gate voltage to select the plurality of pixel circuits.

20. The device of claim 16, wherein the plurality of control circuits comprises a source driver for applying a data voltage to the plurality of pixel circuits.

21. The device of claim 16, wherein the plurality of control circuits comprises a backlight controller for applying a backlight control signal.

22. The device of claim 16, wherein the plurality of control circuits comprises a timing controller for applying a timing control signal.

23. A display device, comprising:
a substrate;
a display panel including a plurality of pixel circuits, at least a portion of the plurality of pixel circuits disposed over or integrated into the substrate and arranged in a display matrix; and
a plurality of control circuits, disposed over or integrated into the substrate, and arranged along a peripheral edge of the display panel so as not to obstruct a pixel aperture.

24. The device of claim 23, wherein the plurality of control circuits includes a plurality of electronic components connected by a plurality of electronic circuits.

25. The device of claim 24, wherein the plurality of control circuits comprises a scan driver for applying a gate voltage to select the plurality of pixel circuits, a source driver for applying a data voltage to the plurality of pixel circuits, a backlight controller for applying a backlight control signal, or a timing controller for applying a timing control signal.
